(19) United States
(12) Patent Application Publication
(10) Pub. No.: US 2008/0104627 A1
(43) Pub. Date: May 1, 2008

(54) SYSTEM AND METHOD FOR RANKING MEDIA

(76) Inventor: Narbeh AVEDISSIAN, Studio City, CA (US)

Correspondence Address: DALINA LAW GROUP, P.C., 7910 IVANHOE AVE. #325, LA JOLLA, CA, 92037, US

(21) Appl. No.: 11/670,987

(22) Filed: Feb. 4, 2007

Related U.S. Application Data
(63) Continuation of application No. 11/553,658, filed on Oct. 27, 2006.

(51) Int. Cl. H04N 7/173; H04N 7/16; H04H 60/33; H04H 9/00

(52) U.S. Cl. 725/25; 725/24; 725/112; 725/13; 725/113

(57) ABSTRACT

A system and method for ranking media. Embodiments enable presenting media in a first venue, obtaining feedback from at least one user and providing an indication whether to present the media in a second venue. The media may be audio, video, and/or text or any combination thereof. The first venue for example may be the Internet or an Internet online community. The second venue may for example be television (cable, broadcast or a DVD variant) or radio. The media may be presented in the first venue and feedback is obtained in any manner, for example via the first venue or over any other medium such as by phone, computer or in any other way. The feedback for example may be based solely on the media or in relation to other media presented. The indication may be provided as to whether to present the media in a second venue.

This application is a continuation of U.S. Utility patent application Ser. No. 11/553,658 filed Oct. 27, 2006, the specification of which is hereby incorporated herein by reference.

### BACKGROUND OF THE INVENTION

1. Field of the Invention

The invention relates to the field of computer software and is more particularly, but not by way of limitation, directed to a system and method for ranking media, where media includes video, audio and text related information.

2. Description of the Related Art

There is currently no known method for ranking media in one venue that provides an indication as to the desirability of presenting the media in a second venue. For example, there is no known system that presents a television pilot to online Internet users and obtains feedback from the users and provides an indication as to whether to present (or disassociate) the media from television, e.g., cable, broadcast of DVD variants. The same holds for audio and text based media, for example songs and articles or books.

Current solutions for studio feature films allow for pre-screenings of movies in a theatre which allows for the gathering of feedback for the movies before they are presented to paying audiences in theatres. Generally, this is done to determine alternate forms of the movie, i.e., alternates endings. In this case the venue is the same, i.e., a movie theatre is used to rank a potential movie or movie ending for example while the movie is eventually shown in some form in a movie theatre. The solution for independent feature films are annual film festivals that are viewed by industry professionals and not the target market. If independent feature films are viewed favorably by the industry professionals (studio executives) they are then purchased by the studio for exploitation. These festivals, e.g., Cannes Film Festival, are not only expensive but have a very high barrier for entry. For television pilots, the process may only include network/studio executives or small audiences who are enlisted to review a pilot on television for eventual presentation on television. Although the executives may have a general feel for the possible success of a given television pilot, they are not the eventual audience.

In terms of audio data, musicians publish their works routinely on the Internet, yet there are no known systems that provide an indication as to whether the audio data should be presented on radio for example. I.e., there is no known system or method that allows for the audio data to be indicated as desirable for a second venue. In addition, there are no known ways for a publisher to obtain feedback from a select reader audience before publishing a book or variations of an ending of a book for example.

In summary, there is no known existing inexpensive open platform for all independent producers, writers and directors to reach a large number of actual viewers/listeners/readers in short period of time and receive immediate feedback, from the actual target market, in the form of a rating, (for example one to five stars-five being best), and for public and private viewer comments to be listed in association with the video/audio/text. There is no known system that can track which viewers have had the best track record (based on whether their highly rated submissions have been picked up) and invite them to be a part of a special panel for determining if a particular media has the qualities that allow for entry into a second venue. In addition, there is no known system that allows studios and independent financiers to acquire projects based on actual target market ratings and votes (e.g., the actual number of views, votes and ratings). Furthermore, these systems do not provide the capability or right to distribute the content via the web or otherwise and create online film and television programming.

Hence, there is a need for such a system and method for ranking media that enables presenting media in a first venue, obtaining feedback from at least one user and providing an indication whether to present the media in a second venue.

### BRIEF SUMMARY OF THE INVENTION

One or more embodiments of the invention are directed to a system and method for ranking media. Embodiments enable presenting media in a first venue, obtaining feedback from at least one user and providing an indication whether to present the media in a second venue. The media may be audio, video, and/or text or any combination thereof.

The first venue for example may be a media presentation device coupled to the Internet or with an Internet online community such as a computer, cell phone or PDA, or an MP3 player such as an iPod®. The second venue may for example be television (cable, broadcast or a DVD variant), radio or theatre. The media may be presented in the first venue and feedback is obtained in any manner. The feedback may be obtained for example via the first venue or over any other medium such as by phone, computer or in any other way. The feedback for example may be based solely on the media or in relation to other media presented.

The indication may be provided as to whether to present the media in a second venue using any relative or absolute ranking system or in any other way for example. The indication may for example indicate that a media has obtained an absolute rank on a particular scale that indicates that the media would be a “hit”. Alternatively, given a group of media, the indication may indicate which if any of the media of the existing group where good enough to present in a second venue.

If a ranking in relation to a first or second venue lowers, the media may be disassociated with the second venue. In the case of disassociation, the media may be modified and presented again in the first venue until it is ranked high enough to show in the second venue. Heretofore, when a television pilot for example has been deemed to be a “non-hit”, then the pilot dies as is presented in that particular format. Embodiments of the invention allow for reworking the pilot until the proper characters or interaction between characters for example is achieved. For audio related media, the system allows for feedback on songs that allows for the reworking of songs that are not yet ready for presentation in a second venue. For text related media, the system allows for a publisher or author for that matter to obtain feedback on a book or article, or on variants of a book or article, for example a set of alternate endings for a book. If the feedback is of high enough value, then the book or article may be published as a hard copy for example.

Any type of ranking system may be utilized in embodiments of the system. In at least one embodiment of the invention each user is permitted to cast a single vote for each item of media associated with the venue. In other cases the system is configured to enable users to vote multiple times about multiple aspects of the media and/or change a ranking given to a particular performance over time. Hence, the popularity of given media may rise and fall over time based on the ongoing feedback provided by the users. In addition, adjustments to the rankings may be made to account for possible accurate or inaccurate predictions. For example, users that accurately predict the viability of media may be given an associated ranking power that gives a greater ability for some users to influence the outcome. Feedback from users who are good trend-spotters may for instance have a higher ability to influence a ranking. Users may also gain a greater ranking power over time as the number of rankings submitted increases. Hence a user who submits only one vote may not be taken into account as much as a user who has submitted numerous votes. Alternatively but not by way of limitation a user's first vote may have a greater weight than subsequent votes. Some users may have a greater weight within a certain genre (e.g., rock music) and a lower weight within other genres (e.g., country music) with respect to a type of media, in this case audio data. Alternatively, some users may more accurately predict the success of game shows versus situation-comedies, or in the film realm, a user may more often predict the success of a drama than a horror movie.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a system architecture diagram.

FIG. 2 illustrates a flow diagram for ranking media in accordance with at least one embodiment of the invention.

### DETAILED DESCRIPTION OF THE INVENTION

One or more embodiments of the invention are directed to a system and method for ranking media. The description set forth herein is exemplary, rather than limiting, and many variations and modifications are within the scope and spirit of the invention. Although numerous specific details are set forth in order to provide a thorough understanding of the present invention, it will be apparent to one of ordinary skill in the art, that embodiments of the invention may be practiced without these specific details. In other instances, well-known features have not been described in detail in order to avoid unnecessarily obscuring the present invention.

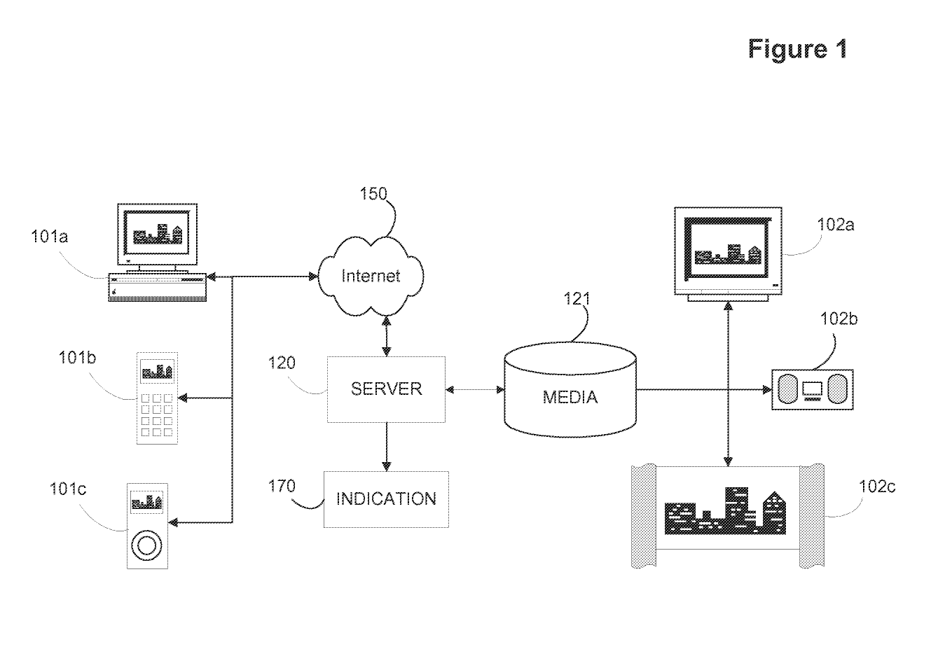

FIG. 1 is a system architecture diagram. Media presentation devices 101a, a computer, 101b, a cell phone and/or PDA and 101c, an MP3 player for example an iPod®, may each be utilized as a first venue to provide media to at least one user. Any device configured to provide media to at least one user may be utilized by the system to present media from server 120. Media may include video and/or audio and/or text for example. The media displayed on media presentation devices 101a-c is stored in media storage device 121 associated with server 120. The media is presented by the system to media presentation devices 101a-c via Internet 150.

The system obtains feedback from a user that has viewed, listened to, or read the media on any desired media presentation device 101a-c. The feedback obtained by the system may be based solely on the media or relative to other media presented. The feedback may flow back from any media presentation device 101a-c through Internet 150 to server 120, or alternatively, may flow through a phone network or text messaging network to server 120. These paths are not shown for brevity, however one skilled in the art will recognize that any method of returning feedback to server 120 is in keeping with the spirit of the invention.

The system provides indication 170 as to whether to present the media in a second venue where the second venue is any medium that enables presentation of the media in audio-video form or via a theatrical presentation. The indication may be in the form of a rating that may be implemented via a web page for example. Any other method of indicating the strength or weakness, the quality or lack thereof, the desirability or lack thereof of media may be utilized in any embodiment of the invention. The indication may be provided as to whether to present the media in a second venue using any relative or absolute ranking system or in any other way for example. The indication may for example indicate that a media has obtained an absolute rank on a particular scale that indicates that the media would be a “hit”. Alternatively, given a group of media, the indication may indicate which if any of the media of the existing group where good enough to present in a second venue. If the indication is positive with respect to a particular media presentation, then the media may be presented to users in a second venue. The second venue may include television 102a, radio 102b or theatre 102c or any other form of venue where a user pays for the media or endures advertisements in lieu of or in addition to paying for the media.

If a ranking of a given media in relation to a first or second venue lowers, then the media may be disassociated with second venue 102a-c. In the case of disassociation, the media may be modified and presented again in first venue 101a-c until it is ranked high enough to present to second venue 102a-c. Heretofore, when a television pilot for example has been deemed to be a “non-hit”, then the pilot dies in that venue. Embodiments of the invention allow for reworking the pilot for example until the proper characters or interaction between characters is achieved.

Any type of ranking system may be utilized in embodiments of the system. In at least one embodiment of the invention each user is permitted to cast a single vote for each item of media associated with venue 101a-c. In other cases the system is configured to enable users to rate, on a scale of lesser to greater value, and vote multiple times with respect to multiple aspects of the media and/or change a ranking given to a particular performance over time. Hence, the popularity of given media may rise and fall over time based on recurring feedback provided by the users. In addition, adjustments to the rankings may be made to account for possible accurate or inaccurate predictions. For example, users that accurately predict the viability of media may be given an associated ranking power that gives a greater ability for some users to influence the outcome of indication 170. Feedback from users who are good trend-spotters may for instance have a higher ability to influence a ranking. Users may also gain a greater ranking power over time as the number of rankings submitted increases. Hence a user who submits only one vote may not be taken into account as much as a user who has submitted numerous votes. Alternatively but not by way of limitation a user's first vote may have a greater weight than subsequent votes. Some users may have a greater weight within a certain genre (e.g., rock music) and a lower weight within other genres (e.g., country music) with respect to a type of media, in this case audio data. Alternatively, some users may more accurately predict the success of game shows versus situation-comedies, or in the film realm, a user may more often predict the success of a drama than a horror movie.

Due to the sensitive nature of media that is presented in the first venue, server 120 may optionally accept an authorization token, for example a cookie, PIN, password, user identification, certificate, or any other method of authenticating the user. Any method of authorizing a user including use of IP address or incoming phone number or caller ID is in keeping with the spirit of the invention. When indication 170 is positive with respect to a given media, then the media is shown in second venue 102a-c to the paying public (or to an audience that witnesses advertisements as paid for by a third party).

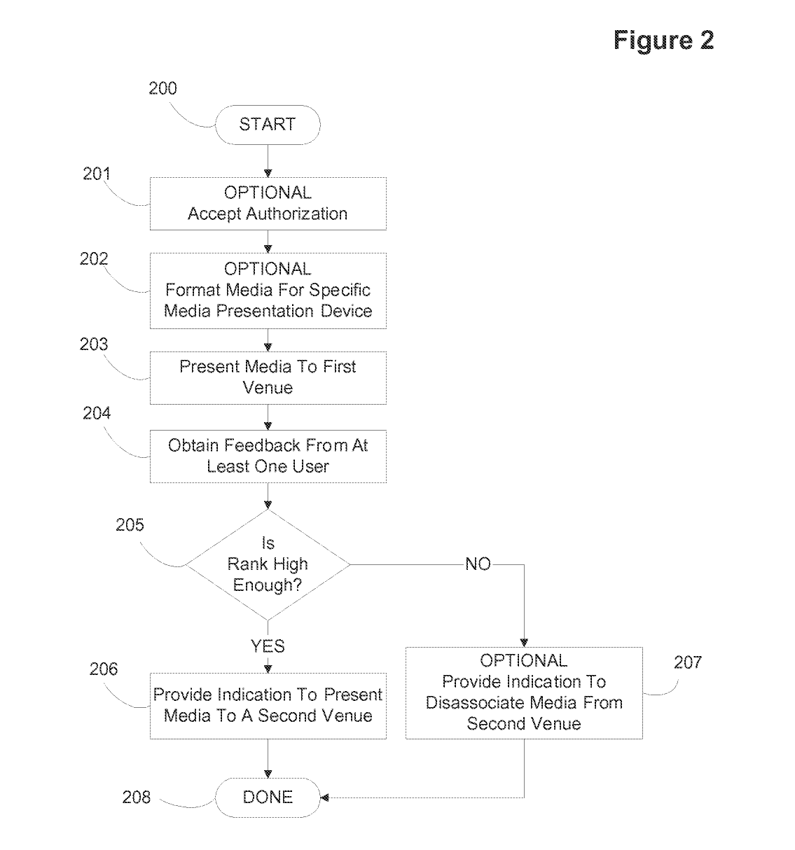

FIG. 2 illustrates a flow diagram for ranking media in accordance with at least one embodiment of the invention. Processing starts at 200 and optionally, the system accepts authorization from a user at 201. The authorization may utilize any mechanism including a cookie, a certificate, a password or any other method of authorizing a user. As a leak of media may cause damage to a producer of a pilot or may cause loss of sales, the media may be optionally watermarked at 201. Watermarking media allows for the source of a media leak to be determined by digitally examining the media file and determining the unique identifier delivered to and associated with a particular user. Optionally, the system may format media for a given media presentation device at 202. This may for example include generating a particular format video, audio or text file format that the media presentation device is capable of utilizing.

The media is presented to a first venue at 203. The first venue may include computers, theatre, cell phones or PDAs, or MP3 players, such as an iPod® for example. The user views/listens/reads the media in the first venue. The user may pause the media and continue to absorb the media at a later time, or alternatively, the user may experience the media in one pass. The system obtains feedback from at least one user at 204. In one or more embodiments of the invention, the user may pause the media and annotate or provide comments directly coupled to the particular scene, verse, or passage where the user feels a comment is appropriate. In addition to providing specific annotation, the feedback may include any type of rating or communication that indicates whether the media as a whole or in part is ready for presentation in a second venue. The feedback may be absolute or relative, e.g., based on an absolute scale or a relative scale in relation to other media for example. Any method of obtaining feedback, whether via the first venue which may be a bidirectional link, or via any other communications link is in keeping with the spirit of the invention. For example, the user may phone in a feedback rating over a telephone network or email or text message a feedback rating to a server that provided the media. The device utilized to provide feedback may or may not be the same device utilized to play the media.

If the feedback is of sufficient value, i.e., the rank is high enough, an indication to present the media to a second venue is given at 206. The rank may be in the form of a web page that includes a ranking of media that a network for example may utilize to view feedback on any number of pilots. Alternatively, the indication may be in the form of a spreadsheet, email, text message, phone call, or any other communication form so long as a user desirous of knowing whether or not a given media is ready for presentation in a second venue where the second venue is any viable medium, format or device for presenting media that has achieved a desired rank (e.g., television, internet, theatre, cell/phone, PDAs, digital media player, Mp3 players, iPod, etc . . . ).

If the rank is not high enough and the media is already associated with the second venue, then the media may be disassociated with the second media at 207. If the media is not already associated with a second venue, then the indication may either be in the form of a negative feedback value or may in the case of messaging embodiments merely result in no transmission of an indication. In either case, the implementer of the system may charge a fee for providing the system and service of ranking media. In the case of a television pilot that is successfully presented in a first venue with positive feedback and an indication that presentation in a second medium is worthwhile, then the implementer of the system may charge a network a fee or profits participation for example. Processing ends at 208.

One or more embodiments of the invention enable an authorized administrator to distribute the media independent of the second venue or through the second venue using a second venue under control of the administrator. The administrator may be the sole distributor of the media unless otherwise remunerated by a third party, by way of a licensing agreement for example, for distribution of the media by that third party.

While the invention herein disclosed has been described by means of specific embodiments and applications thereof, numerous modifications and variations could be made thereto by those skilled in the art without departing from the scope of the invention set forth in the claims.

What is claimed is:

1. A system for ranking media comprising:
a media storage device for storing media;
a server configured to: present said media on said media storage device to a first venue having access to said media;
obtain feedback from at least one user with respect to said media presented in said first venue; and,
provide an indication to present said media in a second venue.

2. The system of claim 1 wherein said server is further configured to provide an indication to disassociate said media with said second venue.

3. The system of claim 1 wherein said indication comprises an absolute ranking or a relative ranking.

4. The system of claim 1 wherein said media comprises video data.

5. The system of claim 4 wherein said first venue comprises an Internet venue.

6. The system of claim 4 wherein said second venue comprises one selected from the group consisting television, analog media playback, digital media playback, theatrical exploitation, and theatrical presentation.

7. The system of claim 1 wherein said media comprises audio data.

8. The system of claim 7 wherein said first venue comprises an Internet venue.

9. The system of claim 7 wherein said audio data comprises music or vocal sounds.

10. The system of claim 7 wherein said second venue comprises radio.

11. The system of claim 1 wherein said server distributes said media for use in said second venue.

12. A computer program product for ranking media comprising computer readable instruction code executing in a tangible memory medium of a computer, said computer readable instruction code configured to:
present said media on said media storage device to a first venue having access to said media;
obtain feedback from at least one user with respect to said media presented in said first venue; and,
provide an indication to present said media in a second venue.

13. The computer program product of claim 12 wherein said computer readable instruction code is further configured to provide an indication to disassociate said media with said second venue.

14. The computer program product of claim 12 wherein said media comprises video data and wherein said first venue comprises an Internet venue and said second venue comprises television or theatrical exploitation or presentation.

15. The computer program product of claim 12 wherein said media comprises audio data or text data and wherein said first venue comprises an Internet venue and said second venue comprises radio or a publication.

16. A method for ranking media comprising:
presenting media stored on a media storage device to a first venue having access to said media;
obtaining feedback from at least one user with respect to said media presented in said first venue; and,
providing an indication to present said media in a second venue.

17. The method of claim 16 further comprising: providing an indication to disassociate said media with said second venue.

18. The method of claim 16 wherein said presenting comprises presenting video data to an Internet venue and wherein said providing said indication results in a presentation of said video data on television or a presentation in a theater.

19. The method of claim 16 wherein said presenting comprises presenting audio data or text data to an Internet venue and wherein said providing said indication results in a presentation of said audio data on radio or said text data in a publication.

20. The method of claim 16 wherein said media is distributed online or via a cell phone system.
